(19) United States
(12) Patent Application Publication
(10) Pub. No.: US 2012/0008193 A1
(43) Pub. Date: Jan. 12, 2012

(54) METHOD FOR EQUALIZING ARBITRARY PARFOCAL LENGTHS OF OBJECTIVES WHEN FOCUSING STEREOMICROSCOPES AND MACROSCOPES

(76) Inventors: Gerhard Möller, Gottingen (DE); Axel Laschke, Gleichen (DE); Thomas Serfling, Jena (DE); Steffen Leidenbach, Reinhausen (DE); Detlef Hein, Gottingen (DE)

(21) Appl. No.: 13/162,765

(22) Filed: Jun. 17, 2011

Related U.S. Application Data
(63) Continuation of application No. PCT/EP2009/009052, filed on Dec. 17, 2009.

(30) Foreign Application Priority Data
Dec. 18, 2008 (DE) 10 2008 063 799.8

(51) Int. Cl. G02B 21/22

(52) U.S. Cl. 359/376

(57) ABSTRACT

The invention is directed to a method for equalizing arbitrary parfocal lengths of objectives when focusing stereomicroscopes and macroscopes, including an objective changer (4) equipped with differently parfocalized and/or non-parfocalized objectives (5), and focusing devices for automatic focusing when changing an object or objective. The focusing devices are controlled by control devices according to object and objective changer data and data for the travel path stored previously in a storage device. When changing non-parfocal objectives (5) arranged in an objective changer (4), automatic focusing is carried out. During an objective change, the danger of a collision between objectives (5) arranged in the objective changer (4) and the object or the object carrier (1.1) due to an unfavorable combination of overall length and parfocal length of the objectives (5) with non-parfocal objectives (5) is detected, an error message is outputted and a parfocality manager is blocked in case of an unfavorable combination in a way such that automatic refocusing cannot be carried out.

### CROSS REFERENCE TO RELATED APPLICATIONS

This application is a continuation application of international patent application PCT/EP 2009/009052, filed Dec. 17, 2009, and claiming priority from German application 10 2008 063 799.8, filed Dec. 18, 2008, and the entire content of both applications is incorporated herein by reference.

### FIELD OF THE INVENTION

The invention relates to a method for equalizing arbitrary focal lengths of objectives when focusing stereomicroscopes and macroscopes, in particular when using objective changers (objective turrets), which are equipped with objectives having the same and/or different parfocal lengths. In this connection, the problem primarily consists in that the focus position is not automatically realized in an objective change of non-parfocalized objectives.

### BACKGROUND OF THE INVENTION

There are objective turrets for stereomicroscopes and macroscopes which can be equipped with different objectives. In this connection, there are groups of parfocal and non-parfocal objectives, whereby in parfocal objectives the parfocal lengths can differ by a few millimeters because of the tolerances which can occur in these objectives. Therefore, even in a proper configuration of a microscope having 3-fold objective changers, that is when focusing on the object with the highest magnifying objective at highest magnification, individual refocusing is required when changing objectives because of the tolerances of the parfocal lengths. In objective changers equipped with objectives having different parfocal lengths the travel path during focusing can be several centimeters. Attention must be paid that no collision between the object and the objective occurs during the objective change and the subsequent refocusing.

Parfocality managers with parfocality assistants so far only exist for compound microscopes with parfocalized objectives. Only short travel paths are required, which is why a collision between the object and the objective can almost be ruled out.

DE 42 30 909 A1 discloses a method for motorically assisted parfocality of parfocalized objectives of a compound microscope having an encoded objective turret for receiving objectives of different magnification with a motorically adjustable microscope stand for focusing. To support the parfocality of the objectives after an object or objective change a control unit and a storage unit are provided by means of which individual focus settings of the objective can be reproducibly stored. After changing the specimen the focus position to be newly set can be approached with a desired objective and the difference between the stored focus position and the new focus position is taken into consideration in the control unit and stored in the storage unit for the correction of the further stored objective positions.

According to this method, only minimal refocusing caused by manufacturing tolerances of the parfocalized objectives can be performed for the realization of precise focusings.

### SUMMARY OF THE INVENTION

It is an object of the invention to provide a method for parfocalizing identical or different parfocal lengths of objectives during focusing on stereomicroscopes and macroscopes, by means of which it is achieved that when both parfocalized objectives and non-parfocalized objectives are changed, the focus position is automatically readjusted without the danger of a collision between the objective and the object or the object carrier.

The method of the invention is for equalizing arbitrary parfocal lengths of objectives when focusing stereo microscopes and macroscopes having an objective changer equipped with different parfocal and/or non-parfocal objectives as well as a focusing arrangement configured for automatic focusing when an object or objective is changed. The method includes the steps of: storing objective data, objective changer data and travel path data in a memory; exchanging parfocal and/or non-parfocal objectives arranged in the objective changer; and, controlling the focusing arrangement with a control unit using the stored objective data, objective changer data and travel path data to perform an automatic focusing when changing the objectives.

Thus, it is advantageous that the control units of the stereomicroscope or macroscope recognize a potential collision danger between objectives arranged in an objective changer and the object or the object carrier, which, in the case of non-parfocal objectives, can be caused by an unfavorable combination of overall length and/or working distance and/or parfocal lengths of the objectives by objective changing and/or automatic focusing.

It is also advantageous that when a collision danger is recognized, a warning or error message is given and/or an automatic objective change and/or automatic refocusing is not carried out by the control units.

Further, it is advantageous that a warning message is given by the control units of the stereomicroscope or macroscope when the travel path of the focusing arrangement exceeds a certain value or certain threshold during the automatic focusing of the objective when there is an objective change or an object change. This value can, for example, be larger than 1 mm.

It can also be advantageous if an automatic focusing or refocusing by the control units is executed only upon confirmation by the user of the stereomicroscope or macroscope.

To achieve a parfocalization of any desired parfocal lengths of objectives when focusing a stereomicroscope or macroscope it is advantageous if the objective data and the objective changer data as well as the data for the travel path for the automatic refocusing during an objective change is processed in a parfocality manager and converted to control commands to the focusing arrangement for refocusing, and if a parfocality assistant (parfocality wizard) for the configuration of the parfocality of the objective changer at the parfocality manager is opened (switched on), and equipping of the objective changer with objectives is checked and confirmed, or in the case of non-confirmation is carried out anew, and that upon confirmation of when a proper due equipping or correct configuration of the objective changer in a first sub-menu of the parfocality assistant an onward switching to a second sub-menu of the parfocality assistant takes place and then the objective having the greatest magnification is recognized by the parfocality assistant and is marked as reference objective on a button of the parfocality assistant in relation to the other objectives provided in the objective changer. The microscope with the reference objective is then focused on the object and the settings are stored as reference values. Then, after an onward switching of the objective changer to the next objective focusing with this objective is performed and these settings are stored. Subsequently, focusing and storing of the settings are carried out with other objectives inserted in the objective changer.

Thus, it is advantageous that in the case of objectives having the same magnification and different parfocal lengths the objective having the smaller parfocal length is chosen as the reference objective and is marked by a separate button in the menu of the parfocality assistant.

Further, it is advantageous if with objectives having the same magnification and the same parfocal length the objective having the smaller working distance is chosen as the reference objective and is marked by a separate button in the menu of the parfocality assistant.

Further, it can be advantageous if, with non-parfocal objectives and without the danger of a collision between the objective and the object or object carrier, a confirmation prompt is carried out when the positioning path exceeds a particular value or a particular threshold.

It is also advantageous if, with non-parfocalized objectives and a collision danger between the objective and the object or object carrier, a focus equalization is excluded.

It is also advantageous if a message is given to the user indicating with which objective combination a collision danger exists.

It can also be advantageous that the danger or possibility of a collision between the objective and the object or object carrier is effected by checking the condition that the overall length of none of the objectives is larger than or equal to the parfocal length of other objectives.

Thus, it is advantageous if at least two of the objective parameters of overall length, parfocal length, and working distance are stored in the storage unit.

It is also advantageous if, in the case of changing the object or the object carrier with parfocal and/or non-parfocal objectives and one-time refocusing with an objective, an automated focus equalization is performed in a change to the other objectives, whereby the settings and data determined and stored during configuration of the parfocality of the objective changer are taken into consideration.

In order to safely avoid a collision between the objective and the object or object carrier when changing objectives with the objective changer, it is advantageous that in the case of non-parfocalized objectives, it is checked already at the time of configuration, that is, at the time of equipping the same whether the selected objectives can be used together, and in the case of a collision danger, switching on of the parfocality manager is excluded. The prerequisite for this is that the overall length of none of the objectives exceeds the parfocal length of the other objectives inserted in the objective changer.

### BRIEF DESCRIPTION OF THE DRAWINGS

The invention will now be described with reference to the drawings wherein:

FIG. 1 shows a stereomicroscope having an objective turret and a focusing arrangement;

FIG. 2 shows a menu of a control unit of a stereomicroscope;

FIG. 3 shows a menu of a parfocality assistant;

FIG. 4 shows a first sub-menu of a parfocality assistant;

FIG. 5 shows a second sub-menu of a parfocality assistant; and,

FIG. 6 shows a third sub-menu of a parfocality assistant.

### DESCRIPTION OF THE PREFERRED EMBODIMENTS OF THE INVENTION

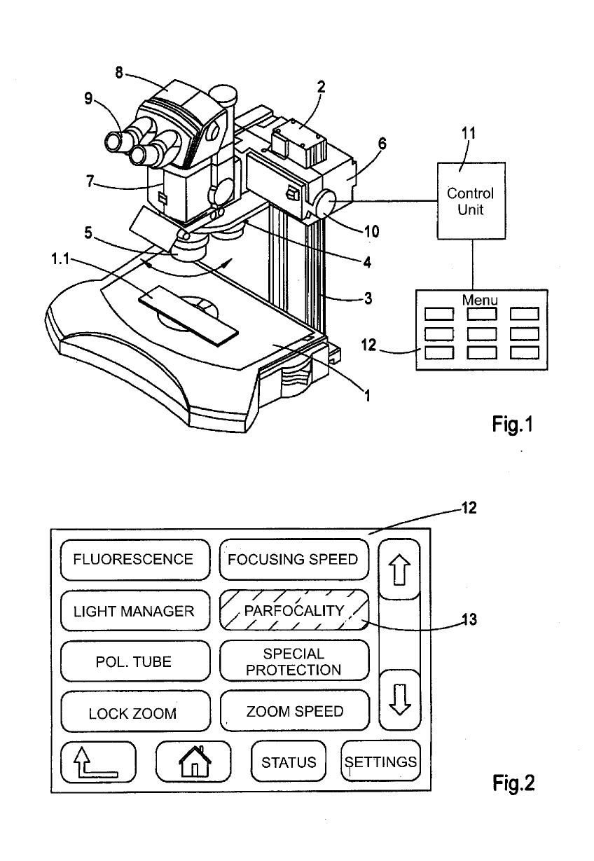

An embodiment of a stereomicroscope shown in FIG. 1 includes a microscope stage 1 on which an object carrier 1.1 is arranged, a microscope stand 2 having guides 3 for a focusing drive 6 carrying an objective changer 4 with objectives 5 inserted therein, as well as a zoom body 7 on which an ocular tube 8 having oculars 9 is arranged. The objective changer 4 can, for example, be configured as an objective turret. A motorized drive can be provided as a focusing arrangement 10 to move the focusing drive 6 along the microscope stand 2 for focusing the microscope. The focusing arrangement 10 is electrically connected to a control unit 11 having a menu 12 and can be controlled by the control unit 11.

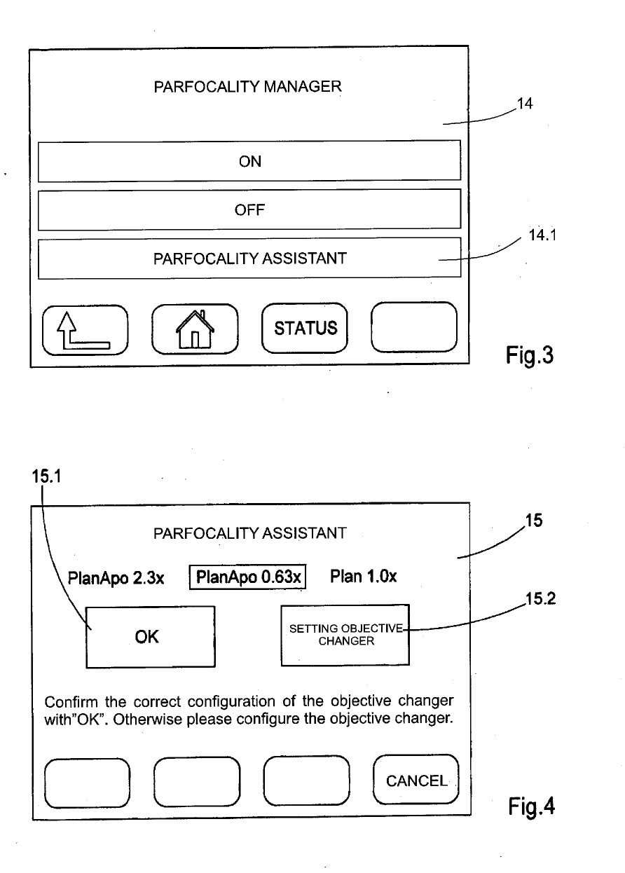

FIG. 2 shows in detail the menu 12 of the control unit 11 having a button 13 or a push-button to open a menu 14 of a parfocality manager which is shown in FIG. 3.

According to the method of the invention for equalizing identical or different parfocal lengths of objectives 5 when focusing on stereomicroscopes, which include an objective turret 4 equipped with different parfocal or non-parfocal objectives 5, as well as focusing arrangements 10 for the automatic focusing when changing the objectives, this focusing arrangement 10 is controlled by a control unit 11 according to previously stored objective and objective-changer data as well as data for the focus difference and the repositioning speed.

Thus, when the objectives 5 are changed, the objective changer 4 arranged on the focusing drive 6 is automatically moved to the focus position, that is, within the two groups of parfocal objectives of the used parfocal lengths 137 mm and 93 mm as well as further permitted configurations of non-parfocal objectives with which there does not necessarily occur a collision between the objective and the object or object carrier 1.1.

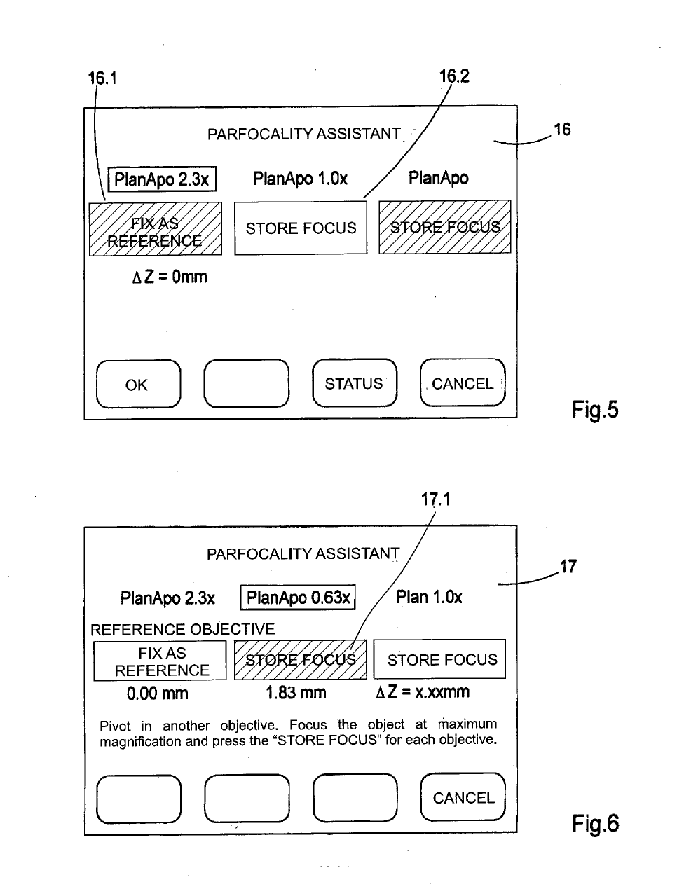

By actuating the button 14.1 (“PARFOCALITY WIZARD”) in the menu 14 of the parfocality manager (FIG. 3), a first sub-menu 15 of a parfocality assistant can be accessed, which is shown in FIG. 4. Here, by pressing a button 15.1 (“OK”) the equipping of the objective changer 4 is confirmed or by pressing a button 15.2 (“SETUP NOSEPIECE”), an equipping of the objective changer 4 is performed. In the case of re-equipping, it is checked in turn whether the objectives 5 can be used together without the risk of a collision according to the above condition, namely that the overall length of none of the objectives is greater than or equal to the parfocal length of the other objectives. In the case of confirming this fact or successfully equipping the objective changer 4 in the sub-menu 15 “SETUP NOSEPIECE” 15.2, an onward switching to a second sub-menu 16 of the parfocality assistant can occur, which is shown in FIG. 5.

If the objectives are not parfocal and if there exists the danger of a specimen or objective collision, there will be a notice in the function “SETUP NOSEPIECE” that the objectives are not parfocal and that there exists the danger of collision. Then, the parfocality manager cannot be enabled.

In the sub-menu 16 of the parfocality assistant, it is detected which objective of the three given objectives has the highest magnification and is marked as a reference objective (in FIG. 5 PlanApo 2.3x) in relation to the other two objectives on a button 16.1 (hatched), for example, marked with “SET REF”. Thereby, when two objectives having the same magnification and unequal parfocal lengths are present, the objective having the shorter parfocal length is to be chosen as the reference objective. With two objectives having the same magnification and same parfocal length, the objective having the shorter working distance is to be selected as the reference objective.

The microscope is focused on the object with the reference objective at the highest zoom setting, that is, with the greatest magnification. By actuating the button 16.1 (“SET REF”) serving as a push-button, the corresponding data and settings relating to the focus position for the reference objective is stored. On the area of the sub-menu 16, the reference value of the focus position (Δz=0 mm) appears below the button 16.1 of the reference objective. Subsequently, the user of the microscope is prompted to switch the objective changer 4 on to the next objective (third sub-menu 17, FIG. 6) and there again to focus with the highest zoom setting and to press the button 17.1 “SAVE FOC” in the third sub-menu 17 (FIG. 6). The focus difference to the reference objective then appears in the area of the sub-menu 17 below the button 17.1 “SAVE FOC” of the next objective (PlanApo 0.63). “SAVE FOC” can only be actuated if “SET REF” has been actuated.

By pressing “SAVE FOC”, the current focus position is determined and the Z-deviation in relation to the reference objective is calculated, saved, and displayed.

Subsequently, upon further rotating of the objective changer, the next objective is focused correspondingly, and the button “SAVE FOC” below the next objective in the sub-menu 17 is actuated. The Z-deviation belonging to the next objective appears in mm in the sub-menu 17 of the parfocality assistant. This step is to be repeated for each additional objective.

During operation when the parfocality assistant is activated, each previously configured focus difference is equalized by appropriate measures after an objective change. The measures can be displacing (shifting) of the focusing drive along a column, displacing of a microscope stage, displacing of the objective relative to the object or displacing of one or more zoom lenses in the zoom body or other appropriate measures.

For working with a motorized outer focus, it is, inter alia, advantageous if in the case of displacement paths which are greater than a particular threshold or a particular value (for example, larger than 1 mm), a confirmation prompt is made at which the user must confirm the automatic focusing.

When changing the object or the object carrier with parfocal and/or non-parfocal objectives and a single refocusing with an objective, an automatic focus equalization is executed when changing to the other objectives, with the settings and data being determined in the configuration of the objective changer. Hereby, after an object change or an object carrier change, a single refocusing with the reference objective at highest magnification must take place before an objective change.

It is understood that the foregoing description is that of the preferred embodiments of the invention and that various changes and modifications may be made thereto without departing from the spirit and scope of the invention as defined in the appended claims.

### CHARACTER REFERENCE LIST

1 Microscope stage
1.1 Object carrier
2 Microscope stand
3 Guide
4 Objective changer
5 Objectives
6 Focusing drive
7 Tube part
8 Ocular tube
9 Ocular
10 Carriage drive
11 Control unit
12, 13, 14 Menu
14.1 Button
15 First sub-menu
15.1 Button
15.2 Button
16 Second sub-menu
16.1 Button
16.2 Button
17 Third sub-menu
17.1 Button

What is claimed is:

1. A method for equalizing arbitrary parfocal lengths of objectives when focusing stereo microscopes and macroscopes having an objective changer equipped with different parfocal and/or non-parfocal objectives as well as a focusing arrangement configured for automatic focusing when an object or objective is changed, said method comprising the steps of:
storing objective data, objective changer data and travel path data in a memory;
changing parfocal and/or non-parfocal objectives arranged in the objective changer; and,
controlling the focusing arrangement with a control unit using the stored objective data, objective changer data and travel path data to perform an automatic focusing when changing said objectives.

2. The method of claim 1, further comprising the step of detecting a collision danger between the objectives arranged in the objective changer and the object or object carrier via the control unit of the stereo microscope or macroscope wherein the collision danger can occur with non-parfocal objectives with unfavorable combinations of overall length and/or work distance and/or parfocal length of the objectives because of an objective change and/or and automatic focusing.

3. The method of claim 2, further comprising the step of providing a warning or fault announcement when a collision danger is detected.

4. The method of claim 2, wherein said auto refocusing is not carried out when a collision danger is detected.

5. The method of claim 1, further comprising the step of providing a warning announcement via the control unit of the stereo microscope or macroscope when the travel path of the focusing arrangement exceeds a specific value for automatically focusing the objective when there is an objective change or an object change.

6. The method of claim 1, wherein an automatic focusing or refocusing is executed only after the user of the stereo microscope or macroscope provides confirmation.

7. The method of claim 1, further comprising the steps of:
processing the following in a parfocality manager: objective data, objective changer data and data for the travel path for automatic refocusing when changing an objective;
converting the objective data, objective changer data and said data for the travel path into control commands for the focusing arrangement for refocusing;
enabling a parfocality assistant on the parfocality manager for the configuration of the parfocality of the objective changer;
in a first sub-menu checking the equipping of the objective changer with objectives and confirming the same or rechecking the equipping of the objective changer in the case of non-confirmation;
switching to a second sub-menu of the parfocality assistant from the first sub-menu of the parfocality assistant if a proper equipping or a correct configuration of the objective changer is confirmed;
recognizing the objective having the highest magnification with the parfocality assistant;
referencing the objective having the highest magnification as a reference objective on a button of the parfocality assistant in relation to the other objectives provided in the objective changer;
focusing the microscope on the object with the reference objective and storing the settings as reference values;
switching the objective changer to the next objective and then focusing with the next objective and storing the settings; and,
sequentially performing focusing and storing of settings for the other objectives provided in the objective changer in sequence.

8. The method of claim 7, wherein when objectives have identical magnification and different parfocal lengths, the objective having the shorter parfocal length is selected as the reference objective and marked with a separate button in the menu of the parfocality manager.

9. The method of claim 7, wherein when objectives have identical magnification and identical parfocal lengths, the objective having the shortest working distance to the object or object carrier is selected as the reference objective and identified with a separate button in the menu of the parfocality manager.

10. The method of claim 1, further comprising the step of when the travel path exceeds a particular value, performing a safety inquiry when the objectives are not parfocalized and there is no danger of a collision between objective and object.

11. The method of claim 1, wherein a focus equalization is precluded when the objectives are non-parfocal and the danger of a collision between the objective and object or object carrier is present.

12. The method of claim 1, further comprising the step of providing an announcement to the user as to which objective combination presents a danger of collision.

13. The method of claim 1, further comprising the step of detecting a potential collision between the objective and the object or object carrier by checking the condition that the overall length of no objective is greater or equal to the parfocal length of the other objectives.

14. The method of claim 1, further comprising the step of storing at least two of the objective parameters of overall length, parfocal length and working distance in the memory.

15. The method of claim 1, further comprising the step of when there is a change of the object or object carrier with parfocal and/or non-parfocal objectives and a one-time refocusing with an objective performing an automatic focus equalization when a change to the other objectives occurs wherewith the settings, which were determined in the configuration of the parafocality of the objective changer, and data are considered.
